(19) United States
(12) Patent Application Publication
(10) Pub. No.: US 2010/0148956 A1
(43) Pub. Date: Jun. 17, 2010

(54) SYSTEM AND METHOD FOR REMOTELY COMMUNICATING WITH A SENSOR/ACTUATOR UNIT USING A CELLULAR GATEWAY DEVICE

(76) Inventors: Ge Song, Fremont, CA (US); Cheng Liang, Woodland, CA (US); Kuang Hwa Lin, San Jose, CA (US)

Correspondence Address: Thomas H. Ham;Wilson & Ham, PMB: 348, 2530 Berryessa Road, San Jose, CA, 95132, US

(21) Appl. No.: 12/641,044

(22) Filed: Dec. 17, 2009

Related U.S. Application Data
(60) Provisional application No. 61/138,491, filed on Dec. 17, 2008.
(60) Provisional application No. 61/138,492, filed on Dec. 17, 2008.
(60) Provisional application No. 61/138,496, filed on Dec. 17, 2008.
(60) Provisional application No. 61/138,497, filed on Dec. 17, 2008.

(51) Int. Cl. G08B 1/08; H04B 7/00

(52) U.S. Cl. 340/539.17; 455/41.2

(57) ABSTRACT

A system and method for remotely communicating with a sensor/actuator unit uses a cellular gateway device to allow a master device to access the sensor/actuator unit by establishing a telecommunication connection between the master device and the cellular gateway device via a cellular network and by establishing a wireless connection between the cellular gateway device and a wireless sensor/actuator device that includes the sensor/actuator unit.

### BACKGROUND OF THE INVENTION

Sensors are used to measure and monitor various parameters for different applications. The parameters may be environmental, mechanical and/or physiological. As an example, sensors may be used to measure humidity, temperature, pollution, pressure, current, motion and position. Actuators are used to activate or control mechanical devices for different applications. As an example, actuators may be used to turn on a light device, a heating system and a security system. Sensors and actuators may be connected to remote controllers to transmit control and measurement signals between the sensors and actuators and the remote controllers. These remote controllers may be connected to the sensors and/or the actuators via a wired or wireless network as part of a sensor/actuator system.

A conventional sensor/actuator system typically requires expensive and complex hardware and/or software to support the system. Consequently, conventional wireless sensor/actuator systems are not practical for personal use.

Thus, there is a need for a sensor/actuator system that does not require expensive and complex hardware and/or software, which allows the system to be used for personal use.

### SUMMARY OF THE INVENTION

A system and method for remotely communicating with a sensor/actuator unit uses a cellular gateway device to allow a master device to access the sensor/actuator unit by establishing a telecommunication connection between the master device and the cellular gateway device via a cellular network and by establishing a wireless connection between the cellular gateway device and a wireless sensor/actuator device that includes the sensor/actuator unit. Thus, a user of the master device can remotely access the sensor/actuator unit regardless of the distance between the master device and the sensor/actuator unit to remotely monitor a parameter and/or to remotely control a system or machine.

A wireless sensor/actuator system in accordance with an embodiment of the invention comprises a wireless sensor/actuator device, a cellular gateway device and a master device. The wireless sensor/actuator device includes a first antenna, first transceiving circuitry and a sensor/actuator unit. The first transceiving circuitry is configured to transmit and receive signals using the first antenna. The first transceiving circuitry is connected to the sensor/actuator unit to transmit signals between the first transceiving circuitry and the sensor/actuator unit. The cellular gateway device includes a second antenna, second transceiving circuitry and a cellular transceiver. The second transceiving circuitry is configured to transmit and receive signals to and from the first transceiving circuitry using the second antenna. The cellular transceiver is configured to connect to a cellular network to communicate to other telecommunication devices using the cellular network. The master device is configured to connect to the cellular gateway device through the cellular network to access the sensor/actuator unit through a wireless connection between the first transceiving circuitry of the wireless sensor/actuator device and the second transceiving circuitry of the cellular gateway device.

A method for remotely communicating with a sensor/actuator unit of a wireless sensor/actuator system in accordance with an embodiment of the invention comprises establishing a telecommunication connection between a master device and a cellular gateway device via a cellular network, establishing a wireless connection between the cellular gateway device and a wireless sensor/actuator device using a first antenna and first transceiving circuitry of the wireless sensor/actuator device and a second antenna and second transceiving circuitry of the cellular gateway device, the first transceiving circuitry being connected to a sensor/actuator unit of the wireless sensor/actuator device, and transmitting signals between the master device and the sensor/actuator unit of the wireless sensor/actuator device using the telecommunication connection between the master device and the cellular gateway device and the wireless connection between the cellular gateway device and the wireless sensor/actuator device so that the master device can communicate with the sensor/actuator unit.

A cellular gateway device of a wireless sensor/actuator system in accordance with an embodiment of the invention comprises an antenna, transceiving circuitry, and a cellular transceiver. The transceiving circuitry is connected to the antenna. The transceiving circuitry is configured to establish a wireless connection with another transceiving circuitry of a wireless sensor/actuator device that includes a sensor/actuator unit. The cellular transceiver is configured to establish a telecommunication connection with a master device using a cellular network to allow the master device to communicate with the sensor/actuator unit through the telecommunication connection between the master device and the cellular gateway device and the wireless connection between the transceiving circuitry of the cellular gateway device and the another transceiving circuitry of the sensor/actuator device.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a diagram of a wireless sensor/actuator system in accordance with an embodiment of the invention.

FIG. 2 is a block diagram of transceiving circuitry of the wireless sensor/actuator system of FIG. 1 in accordance with an embodiment of the invention.

FIG. 3 is a block diagram of a cellular gateway device of the wireless sensor/actuator system of FIG. 1 in accordance with an embodiment of the invention.

FIG. 4 is a block diagram of a master device of the wireless sensor/actuator system of FIG. 1 in accordance with an embodiment of the invention.

FIG. 5 is a diagram of a wireless sensor/actuator system in accordance with a particular implementation of an embodiment of the invention.

FIG. 6 is a diagram of a wireless sensor/actuator system in accordance with another particular implementation of an embodiment of the invention.

FIG. 7 is a diagram of a wireless sensor/actuator system in accordance with another particular implementation of an embodiment of the invention.

FIG. 8 is a process flow diagram of a method for remotely communicating with a sensor/actuator unit of a wireless sensor/actuator system in accordance with an embodiment of the invention.

### DETAILED DESCRIPTION

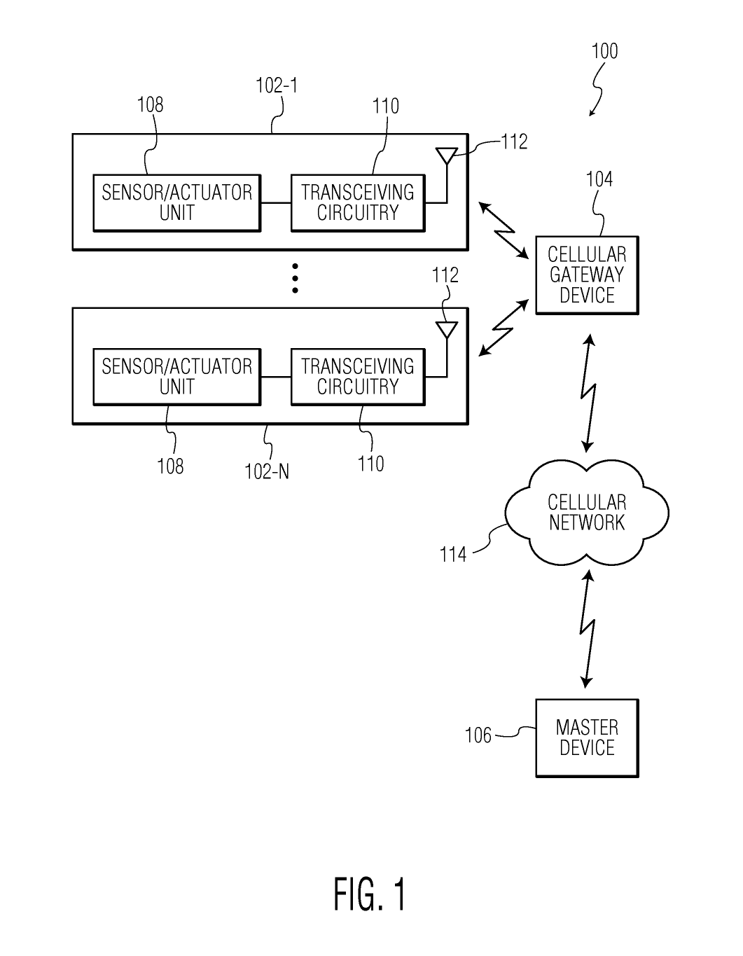

With reference to FIG. 1, a wireless sensor/actuator system 100 in accordance with an embodiment of the invention is shown. As shown in FIG. 1, the wireless sensor/actuator system 100 includes a number of wireless sensor/actuator devices 102-1 . . . 102-N, a cellular gateway device 104 and a master device 106. As described in more detail below, the wireless sensor/actuator system 100 allows a user to remotely communicate with one or more of the sensor/actuator devices 102-1 . . . 102-N using the master device 106 via the cellular gateway device 104. The sensor/actuator devices 102-1 . . . 102-N may be used to measure various environmental, mechanical and/or physiological parameters and/or to actuate or control various electrical and/or mechanical systems or machines. The wireless sensor/actuator system 100 does not require expensive and complex hardware and/or software, which makes the system practical enough to be used for personal use.

Each of the sensor/actuator devices 102-1 . . . 102-N includes a sensor/actuator unit 108, transceiving circuitry 110 and an antenna 112. The sensor/actuator devices 102-1 . . . 102-N may also include other common components for portable devices, such as a battery, power management circuitry and interface circuitry, which are not shown. The sensor/actuator unit 108 may include any sensor that is configured to sense or measure one or more environmental, mechanical and/or physiological parameters, such as temperature (body or environment), light, motion, sound, pressure, humidity, personal ECG signal, heart rate, blood pressure, blood glucose and other parameters that can be sensed or measured, and to output signals that represent the sensed parameters. Alternatively, the sensor/actuator unit 108 may include any actuator that is configured to actuate or control any mechanical and/or electrical systems and machines, such as lighting devices, heating systems and security systems, in response to control signals applied to the actuator. In some embodiments, the sensor/actuator unit 108 may include more than one sensor, more than one actuator or a combination of one or more sensors and one or more actuators.

The transceiving circuitry 110 is connected to the sensor/actuator unit 108 to transmit signals between the transceiving circuitry and the sensor/actuator unit, such as sensed or measurement signals from the sensor/actuator unit to the connected transceiving circuitry or control signals from the transceiving circuitry to the sensor/actuator unit. The transceiving circuitry 110 is also connected to the antenna 112, which is used to establish a wireless connection with compatible transceiving circuitry of the cellular gateway device 104, which is described below. The transceiving circuitry 110 may be configured to perform wireless communication with a relatively short-range wireless communication protocols, such as Ultra-low power Bluetooth (registered trademark of Bluetooth SIG, Inc.), Bluetooth (registered trademark of Bluetooth SIG, Inc.), Zigbee (registered trademark of Zigbee Alliance), or other protocols, and may utilize a short-range communication system (e.g., 433 MHz, 886 MHz, 928 MHz and 2.4 GHz ISM band, or 5.8 GHz ISM band communication system), or any combination thereof

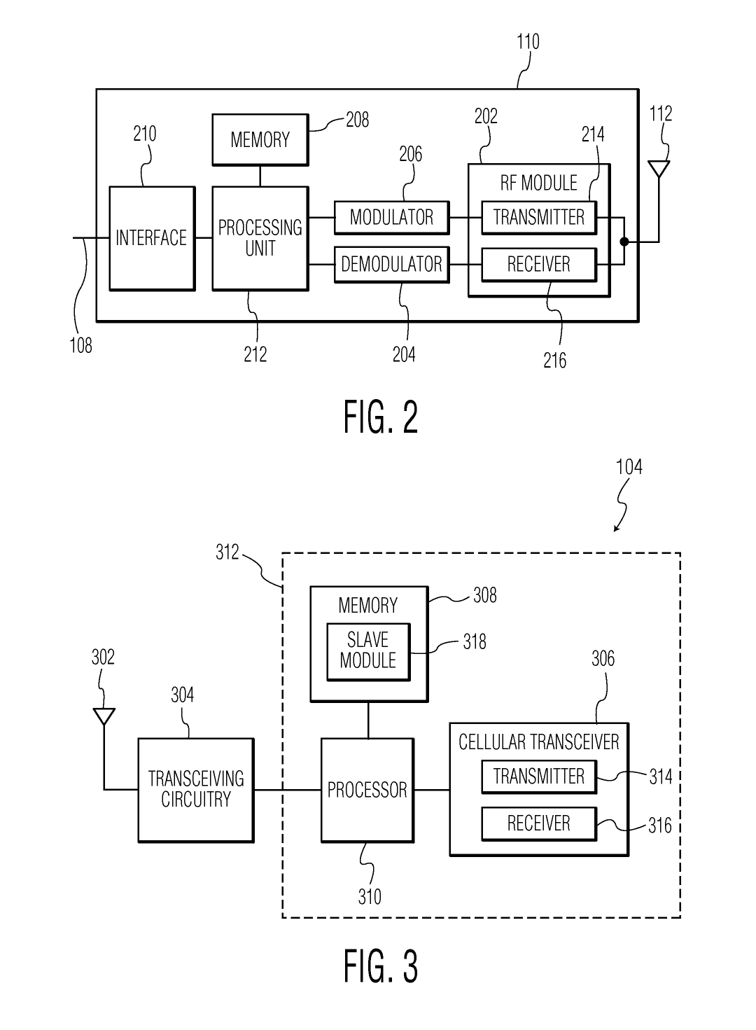

Turning now to FIG. 2, components of the transceiving circuitry 110 in accordance with an embodiment of the invention are shown. As shown in FIG. 2, the transceiving circuitry 110 includes a radio frequency (RF) module 202, a demodulator 204, a modulator 206, memory 208, an interface 210 and a processing unit 212. The RF module 202 includes a transmitter 214 and a receiver 216 to transmit and receive RF signals in accordance with a predefined communication protocol using the antenna 112. The demodulator 204 is connected to the receiver 216 to demodulate the incoming signals. The demodulated signals are then transmitted to the processing unit 212. The modulator 206 is connected to the transmitter 214 to modulate the outgoing signals from the processing unit 212 for transmission.

The processing unit 212 is configured to control various active components of the transceiving circuitry 110, such as the RF module 202, the demodulator 204 and the modulator 206. The processing unit 212 is also configured to process incoming signals received by the receiver 216 and to process outgoing signals to be transmitted via the transmitter 214. The processing unit 212 is also configured to communicate with the sensor/actuator unit 108 via the interface 210. The processing unit 212 is also connected to the memory 208, which is used store data needed by the transceiving circuitry 110 to function. The processing unit 212 may be a general-purpose digital processor, such as a microprocessor or microcontroller. In other embodiments, the processing unit 212 may be a special-purpose processor, such as a digital signal processor. In still other embodiments, the processing unit 212 may be another type of controller or a field programmable gate array (FPGA).

Turning to FIG. 3, components of the cellular gateway device 104 in accordance with an embodiment of the invention are shown. As shown in FIG. 3, the cellular gateway device 104 includes an antenna 302, transceiving circuitry 304, a cellular transceiver 306, memory 308 and a processor 310. In an embodiment, the cellular transceiver 306, the memory 308 and the processor 310 are part of a conventional cellular phone 312, which may include additional components commonly found in cellular phones, such as a display, a microphone, a speaker and a keypad, which are not shown or described herein so as to not obscure the inventive features of the sensor/actuator system 100. As an example, the cellular phone 312 may be configured use communication protocols, such as GSM, GSM plus EDGE, CDMA, WCDMA, CDMA2000 and other cellular protocols. However, the cellular phone 212 can be any type of a cellular phone using any cellular technology or standard.

In some embodiments, the cellular gateway device 104 need not be constructed to include a user interface (e.g., a screen and a keypad) and software to interact with users. However, the cellular gateway device 104 may include some form of limited interface and software, such as, for example, on-off switch, reset switch, power indicator and network presence indicator. The cellular gateway device 104 may include circuitry and software that can perform software upgrading from the master device 106.

In the illustrated embodiment, the antenna 302 and the transceiving circuitry 304 are external to the cellular phone 312. However, in other embodiments, the antenna 302 and the transceiving circuitry 304 may be incorporated with the cellular transceiver 306, the memory 308 and the processor 310 in a single integrated device.

The transceiving circuitry 304 of the cellular gateway device 104 is configured to establish a wireless connection with each of the transceiving circuitries 110 of the sensor/actuator devices 102-1 . . . 102-N. As described above, the wireless connection may be a short-range wireless connection. In an embodiment, the transceiving circuitry 304 of the cellular gateway device 104 may be similar or identical to the transceiving circuitries 110 of the sensor/actuator devices 102-1 . . . 102-N. However, in other embodiments, the transceiving circuitry 304 may differ from the transceiving circuitries 110 of the sensor/actuator devices 102-1 . . . 102-N, but still configured to communicate with the transceiving circuitries of the sensor/actuator devices. The transceiving circuitry 304 is connected the cellular phone 312, e.g., the processor 310 via an interface of the transceiving circuitry.

The cellular transceiver 306 includes a cellular transmitter 314 configured to transmit outgoing signals from a cellular network 114 (shown in FIG. 1) and a cellular receiver 316 configured to receive incoming signals from the cellular network. The cellular transmitter 314 and the cellular receiver 316 are well known components of a cellular phone, and thus, are not described herein in detail. The cellular transceiver 306 is connected to the processor 310 to receive the outgoing data for transmission and to send the received data for processing.

The processor 310 is configured to control various active components of the cellular gateway device 104, such as the cellular transceiver 306, to execute functions associated with making telephone calls and/or other functions that can be performed on cellular phones, such as text messaging, gaming and taking pictures. The processor 310 is also configured to process incoming signals received by the cellular receiver 316 and to process signals being transmitted via the cellular transmitter 316. The processor 310 may be a general-purpose digital processor, such as a microprocessor or microcontroller. In other embodiments, the processor 310 may be a special-purpose processor, such as a digital signal processor. In still other embodiments, the processor 310 may be another type of controller or an FPGA. The processor 310 is connected to the memory 308, which is used to store data needed by the cellular gateway device 104. The memory 308 may also be used to store a remote slave module 318, which when executed by the processor 310 initiates a remote slave application. In this embodiment, the remote slave module 318 is implemented as software stored in the memory 308. However, in other embodiments, the remote slave module 318 may be implemented in any combination of software, hardware and firmware.

The remote slave application of the cellular gateway device 104 is configured to communicate with a remote master application, which is running on the master device 106. The remote slave application communicates with the remote master application using predefined communication protocols when a telecommunication connection is made between the master device 106 and the cellular gateway device 104 through the cellular network 114. The remote slave application is also configured to communicate with the sensor/actuator units 108 of the sensor/actuator devices 102-1 . . . 102-N using the wireless connections between the transceiving circuitry 304 of the cellular gateway device 104 and the transceiving circuitries of the sensor/actuator devices. The remote slave application is further configured to perform one or more operations that depend on the configuration of the wireless sensor/actuator system 100. As an example, if the wireless sensor/actuator system 100 is configured to sense or monitor one or more parameters using one or more of the sensor/actuator devices 102-1 . . . 102-N, the remote slave application may perform operations to collect several data samples from the sensor/actuator units and then pass the data samples to the master device 106. As another example, if the wireless sensor/actuator system 100 is configured to control one or more systems or machines using the sensor/actuator units 108, the remote slave application may perform operations to send control signals to the sensor/actuator units in response to instructions from the master device 106. Thus, the remote slave application facilitates the relay of collected data from the sensor/actuator units 108 to the master device 106 or the relay of instructions from the master device to the sensor/actuator units so that the master device can remotely access the sensor/actuator units via the cellular gateway device 104.

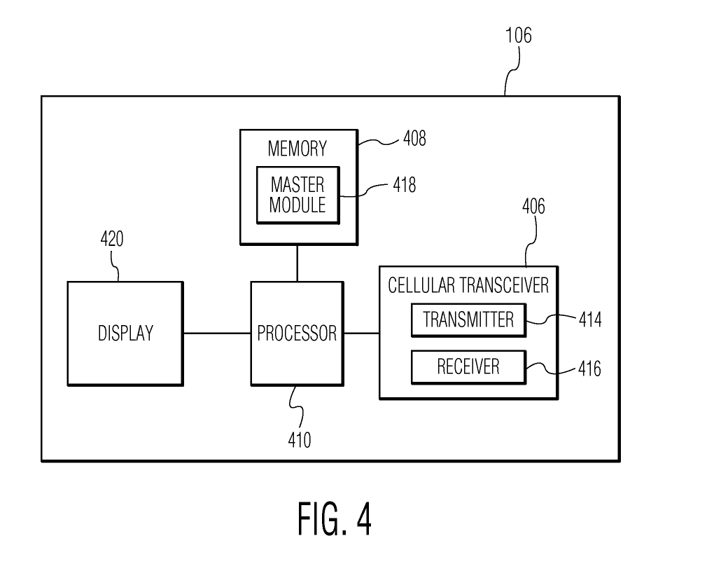

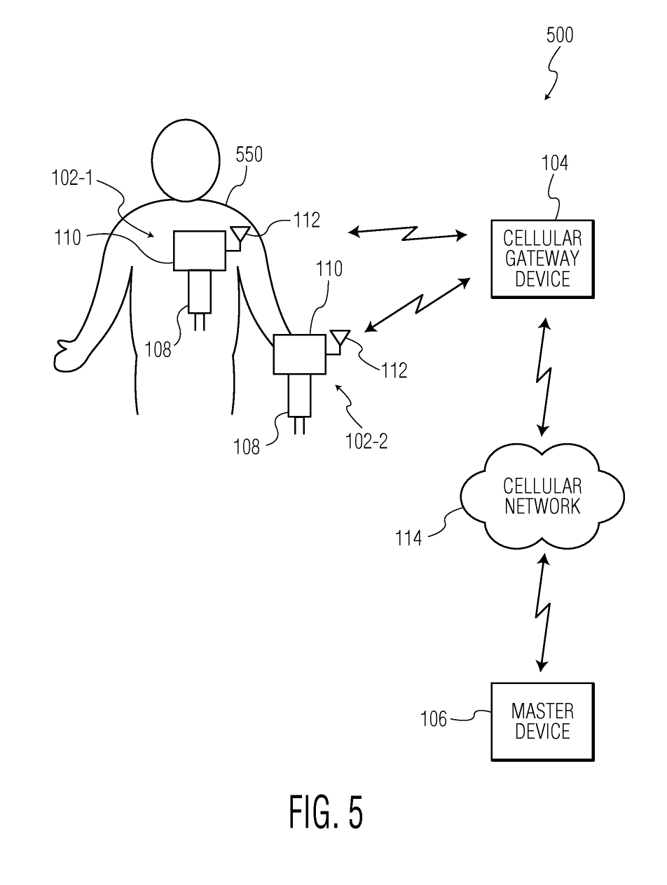

The master device 106 is configured to establish a telecommunication connection with the cellular gateway device 104 through the cellular network 114. As illustrated in FIG. 4, the master device 106 includes a remote master module 418, which initiates the remote master application when executed. In an embodiment, the master device 106 is a cellular phone, which can run the remote master application. An example of such a master device may be a cellular phone, such as iPhone (registered trademark of Apple Inc.), Android phone (registered trademark of Google, Inc.), mobile internet device (MID) and other smart phone. In this embodiment, as shown in FIG. 4, the master device 106 includes a cellular transceiver 406, memory 408, and a processor 410. These components are similar to the cellular transceiver 306, the memory 308 and the processor 310 of the cellular gateway device 104. In the illustrated embodiment, the master device 106 also includes a display 420. The master device 106 may also include additional components commonly found in cellular phones, such as a microphone, a speaker and a keypad, which are not shown. As illustrated in FIG. 4, the remote master module 418 may be stored in the memory 408. In this embodiment, the remote master module 418 is implemented as software stored in the memory 408. However, in other embodiments, the remote master module 418 may be implemented in any combination of software, hardware and firmware.

The remote master application of the master device 106 is configured to communicate with the remote slave application, which is running on the cellular gateway device 104. The remote master application communicates with the remote slave application using the predefined communication protocols when a telecommunication connection is made between the master device 106 and the cellular gateway device 104 through the cellular network 114. The remote master application is further configured to perform one or more operations that depend on the configuration of the wireless sensor/actuator system 100. As an example, if the wireless sensor/actuator system 100 is configured to sense or monitor one or more parameters using one or more of the sensor/actuator devices 102-1 . . . 102-N, the remote master application may perform operations to receive data samples collected by the remote slave application of the cellular gateway device 104 from the wireless sensor/actuator devices 102-1 . . . 102-N and process the received data for use by the user of the master device 106, which may involve performing computations using the received data samples to indirectly measure one or more parameters and/or displaying the data samples or the computed parameters on the display 420 of the master device in a user-friendly format. As another example, if the wireless sensor/actuator system 100 is configured to control one or more systems or machines using one or more of the wireless sensor/actuator devices 102-1 . . . 102-N, the remote master application may send instructions to the remote slave application of the cellular gateway device 104 in response to user commands entered into the master device 106 so that the remote slave application applies control signals to the appropriate sensor/actuator units 108 of the wireless sensor/actuator devices. The remote master application may also provide a user interface for a user to control the remote master application. Thus, the remote master application allows a user to remotely access one or more of the sensor/actuator units 108 for data collection and/or for remote control of one or more systems or machines via the cellular gateway device 104.

Turning now to FIG. 5, a wireless sensor/actuator system 500 in accordance with a particular implementation of an embodiment of the invention is shown. In FIG. 5, similar reference numbers are used to identify elements of the wireless sensor/actuator system 500 that are similar or identical to elements in the wireless sensor/actuator system 100 of FIG. 1. In this implementation, the wireless sensor/actuator system 500 is designed to monitor one or more physiological parameters of a person 550 of interest, such as body temperature, heart rate, electrocardiogram (ECG or EKG) signals, and blood pressure from direct measurement and oximetry, blood glucose and body mass index from indirect measurements. Consequently, the wireless sensor/actuator devices 102-1 and 102-2, the cellular gateway device 104 and the master device 106 of the wireless sensor/actuator system 500 are configured to facilitate this monitoring process. Although only two wireless sensor/actuator devices are shown in FIG. 5, the wireless sensor/actuator system 500 may include any number of wireless sensor/actuator devices in other embodiments.

In this implementation, each of the sensor/actuator units 108 of the wireless sensor/actuator devices 102-1 and 102-2 includes a sensor configured to measure one or more physiological parameters of the person 550 of interest, or to measure one or more physiological characteristics of the person of interest that provide information regarding one or more physiological parameters of the person of interest. As an example, the sensor/actuator units 108 of the wireless sensor/actuator devices 102-1 and 102-2 may include a heartbeat sensor, a temperature sensor and/or a blood pressure sensor. The sensor/actuator units 108 of the wireless sensor/actuator devices 102-1 and 102-2 are configured to generate data samples in response to the parameters being measured or sensed by the sensors. The measured data samples are then transmitted as wireless signals to the cellular gateway device 104 using the wireless connection between one or both of the wireless sensor/actuator devices 102-1 and 102-2 and the cellular gateway device.

The remote slave application of the cellular gateway device 104 in this implementation is configured to collect the received data samples of the parameters from one or both of the wireless sensor/actuator devices 102-1 and 102-2 and pass the collected data samples to the master device 106 using the telecommunication connection between the cellular gateway device 104 and the master device. In addition, the remote master application of the master device 106 is configured to receive data samples collected by the remote slave application from the wireless sensor/actuator devices 102-1 and 102-2 and process the received data for use by the user of the master device, which may involve performing computations using the received data samples to indirectly measure one or more parameters, such as oximetry, blood glucose and body mass index, and/or displaying the data samples or the computed parameters on the display of the master device in a user-friendly format.

One of the advantages of the wireless sensor/actuator system 500 is that a user can use the master device 106 to monitor physiological parameters of the person 550 of interest continuously and remotely regardless of the distance between the user of the master device and the person of interest. For example, a doctor in his office may use his/her cellular phone as the master device 106 to check the temperature, the heart rate, the blood pressure and/or other vital signals of a patient, who is at home.

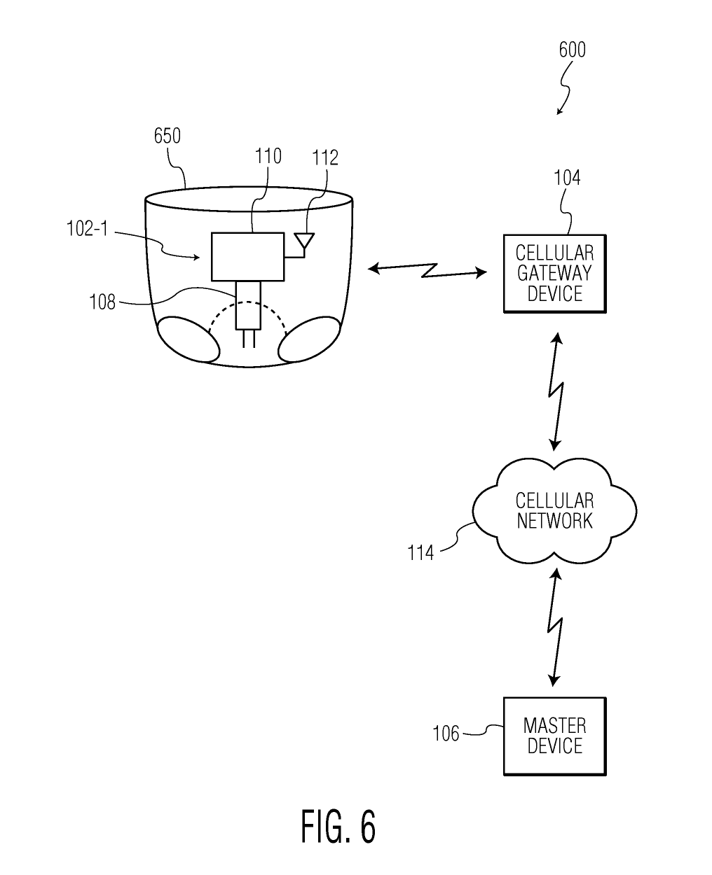

Turning now to FIG. 6, a wireless sensor/actuator system 600 in accordance with another particular implementation of an embodiment of the invention is shown. In FIG. 6, similar reference numbers are used to identify elements of the wireless sensor/actuator system 600 that are similar or identical to elements in the wireless sensor/actuator system 100 of FIG. 1. In this implementation, the wireless sensor/actuator system 600 is designed to monitor a diaper 650 to detect the presence of urine and/or feces. Consequently, the wireless sensor/actuator device 102-1, the cellular gateway device 104 and the master device 106 of the wireless sensor/actuator system 600 are configured to facilitate this monitoring process. Although only one wireless sensor/actuator device is shown in FIG. 6, the wireless sensor/actuator system 600 may include more than one wireless sensor/actuator device in other embodiments.

In this implementation, the sensor/actuator unit 108 of the wireless sensor/actuator device 102-1 includes a sensor that can be attached to the diaper 650, which is configured to detect the presence of urine and/or feces in the diaper.

As an example, the sensor/actuator unit 108 may include an external or built-in two point or multipoint probes to detect the resistance of diaper absorbing chemicals, such as superabsorbent polymers, for sensing urine. In another example, the sensor/actuator unit 108 may include an external or built-in two point or multipoint probes to detect the pressure or capacitance in the diaper 650 for sensing feces, or combination of detecting resistances and pressure for sensing both urine and feces. The sensor/actuator unit 108 of the wireless sensor/actuator device 102-1 is configured to generate signals that represent the presence or absence of urine and/or feces in the diaper 650. The sensed signals are then transmitted as wireless signals to the cellular gateway device 104 using the wireless connection between the wireless sensor/actuator device 102-1 and the cellular gateway device.

The remote slave application of the cellular gateway device 104 in this implementation is configured to collect the received signals from the wireless sensor/actuator device 102-1 and pass the received signals to the master device 106 using the telecommunication connection between the cellular gateway device and the master device. In addition, the remote master application of the master device 106 is configured to receive the signals collected by the remote slave application from the wireless sensor/actuator device 102-1 and process the received data for use by the user of the master device, which may involve performing data analysis and/or displaying the received signals or the results of the data analysis on the display of the master device in a user-friendly format.

One of the advantages of the wireless sensor/actuator system 600 is that a user can use the master device 106 to monitor the diaper 650 worn by a person of interest continuously and remotely regardless of the distance between the user of the master device and the person of interest. For example, a parent may use his/her cellular phone as the master device 106 to check the diaper 650 on his/her baby to ensure that the diaper is changed on time even though the parent may be in a different room or in an office, which may be in another city.

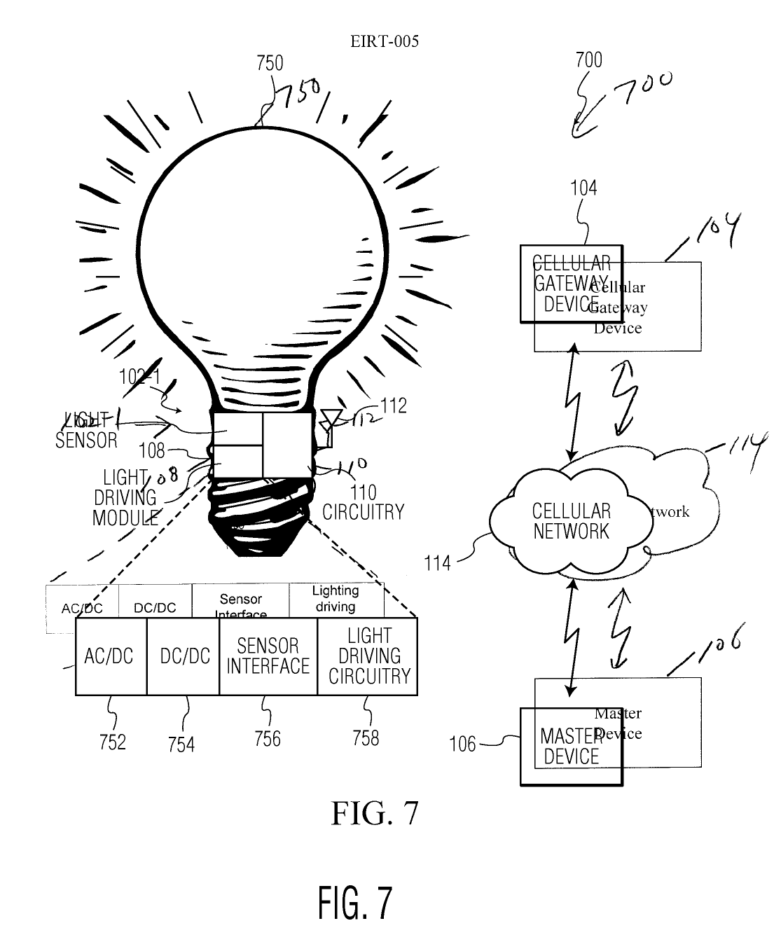

Turning now to FIG. 7, a wireless sensor/actuator system 700 in accordance with another particular implementation of an embodiment of the invention is shown. In FIG. 7, similar reference numbers are used to identify elements of the wireless sensor/actuator system 700 that are similar or identical to elements in the wireless sensor/actuator system 100 of FIG. 1. In this implementation, the wireless sensor/actuator system 700 is designed to sense lighting conditions around a lighting device 750 and control the lighting device to turn on or off the lighting device and/or to change the brightness of the lighting device. The lighting device 750 may be a regular light bulb, a light emitting diode (LED) lighting source or other green lighting device. Consequently, the wireless sensor/actuator device 102-1, the cellular gateway device 104 and the master device 106 of the wireless sensor/actuator system 700 are configured to facilitate this monitoring and controlling process. Although only one wireless sensor/actuator device is shown in FIG. 7, the wireless sensor/actuator system 700 may include more than one wireless sensor/actuator device in other embodiments.

In this implementation, the sensor/actuator unit 108 of the wireless sensor/actuator devices 102-1 includes a light sensor and a light driving module. The light sensor is used to sense the current ambient lighting condition around the lighting device 750. As an example, the light sensor may be a photodiode or other light detector. The light driving module is configured to turn on or off the lighting device 750 and/or to change the brightness of the lighting device by controlling the current applied to the lighting device. In an embodiment, the light sensor and/or the light driving module are incorporated into the lighting device 750, which may be a regular light bulb, so that the lighting device can be used in traditional lamps or lighting fixtures.

As shown in FIG. 7, the light driving module in accordance with an embodiment of the invention includes an AC-to-DC converter 752, a DC-to-DC converter 754, a sensor interface 756 and light driving circuitry 758. The AC-to-DC converter 752 is configured to convert AC supplying power into DC supplying power. The DC-to-DC converter 754 is configured to convert the DC supplying power another DC supplying power at a different voltage to be used by the sensor interface 756 and/or the light driving circuitry 758. The sensor interface 756, which is connected to the light sensor, is configured to amply the signal from the light sensor before being transmitted to the transceiving circuitry 110. The light driving circuitry 758 is configured to control the current being applied to the lighting device to turn on or off the lighting device and/or to change the brightness of the lighting device. The light driving circuitry 758 is connected to the transceiving circuitry 110, which provides control signals to the light driving circuitry in response to instructions from the master device 106.

The remote slave application of the cellular gateway device 104 in this implementation is configured to collect the signals from the light sensor of the sensor/actuator unit 108 that are transmitted from the wireless sensor/actuator device 102-1 and pass the received signals to the master device 106 using the telecommunication connection between the cellular gateway device and the master device. Furthermore, the remote slave application is configured to send control signals to the light driving circuitry 758 of the sensor/actuator unit 108 in response to instructions from the master device 106 to control the lighting device 750.

The remote master application of the master device 106 in this implementation is configured to receive the signals collected by the remote slave application from the light sensor of the wireless sensor/actuator device 102-1 and process the received signals for use by the user of the master device, which may involve indicating the ambient lighting conditions around the lighting device 750 on the display of the master device. The remote master application is also configured to provide a user interface for the user of the master device 106 to control the lighting device 750 by sending instructions to the light driving circuitry of the sensor/actuator unit 108 via the cellular gateway device 104.

One of the advantages of the wireless sensor/actuator system 700 is that a user can use the master device 106 to monitor and control the lighting device 750 remotely regardless of the distance between the user of the master device and the lighting device. For example, a user may use his/her cellular phone as the master device 106 to check and turn on/off lighting devices in an office, which may be located in another city.

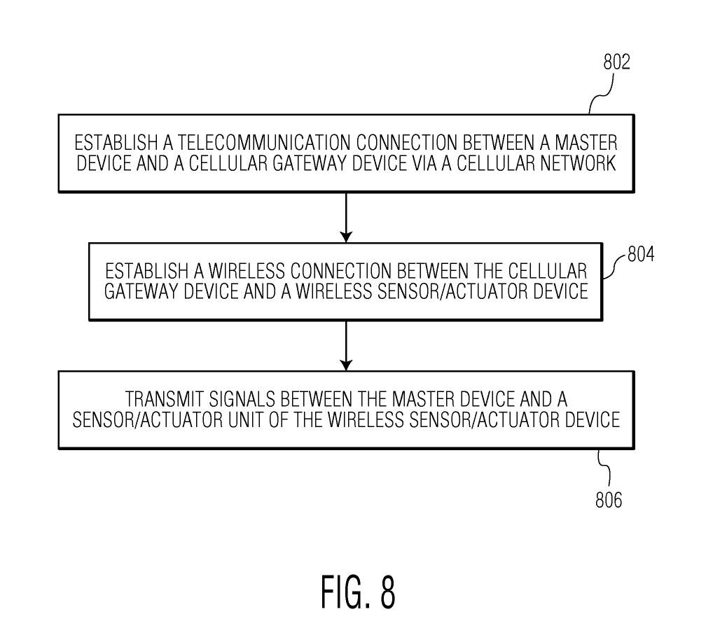

A method for remotely communicating with a sensor/actuator unit of a wireless sensor/actuator system in accordance with an embodiment of the invention is described with reference to a flow diagram of FIG. 8. At block 802, a telecommunication connection is established between a master device and a cellular gateway device via a cellular network. Next, at block 804, a wireless connection is established between the cellular gateway device and a wireless sensor/actuator device using a first antenna and first transceiving circuitry of the wireless sensor/actuator device and a second antenna and second transceiving circuitry of the cellular gateway device. The first transceiving circuitry is connected to a sensor/actuator unit of the wireless sensor/actuator device. Next, at block 806, signals are transmitted between the master device and the sensor/actuator unit of the wireless sensor/actuator device using the telecommunication connection between the master device and the cellular gateway device and the wireless connection between the cellular gateway device and the wireless sensor/actuator device so that the master device can communicate with the sensor/actuator unit.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless sensor/actuator system comprising:
a wireless sensor/actuator device including a first antenna, first transceiving circuitry and a sensor/actuator unit, the first transceiving circuitry being configured to transmit and receive signals using the first antenna, the first transceiving circuitry being connected to the sensor/actuator unit to transmit signals between the first transceiving circuitry and the sensor/actuator unit;
a cellular gateway device including a second antenna, second transceiving circuitry and a cellular transceiver, the second transceiving circuitry being configured to transmit and receive signals to and from the first transceiving circuitry using the second antenna, the cellular transceiver being configured to connect to a cellular network to communicate to other telecommunication devices using the cellular network; and
a master device configured to connect to the cellular gateway device through the cellular network to access the sensor/actuator unit through a wireless connection between the first transceiving circuitry of the wireless sensor/actuator device and the second transceiving circuitry of the cellular gateway device.

2. The system of claim 1, wherein the sensor/actuator unit includes a sensor configured to measure one or more physiological parameters of a person of interest, or to measure one or more physiological characteristics of the person of interest that provide information regarding one or more physiological parameters of the person of interest.

3. The system of claim 2, wherein the sensor is one of a temperature sensor, a heartbeat sensor and a blood pressure sensor.

4. The system of claim 1, wherein the sensor/actuator unit includes one or more probes configured to detect at least one of resistance, pressure and capacitance to detect urine and/or feces.

5. The system of claim 1, wherein the sensor/actuator unit includes a light sensor and a light driving module configured to control a lighting device.

6. The system of claim 5, wherein the light driving module is configured to control current applied to the lighting device.

7. The system of claim 1, wherein the master device is a cellular phone.

8. The system of claim 1, wherein the cellular gateway device includes a remote slave application and the master device includes a remote master application, the remote slave application being configured to collect data samples generated by the sensor/actuator unit and transmitted to the cellular gateway device via the first and second transceiving circuitries, the remote slave application being further configured to pass the collected data samples to the master device, the remote master application being configured to process the data samples to present the data samples or any parameter computed from the data samples to a user of the master device.

9. The system of claim 1, wherein the cellular gateway device includes a remote slave application and the master device includes a remote master application, the remote master application being configured to provide a user interface for a user of the master device to enter commands to control the sensor/actuator unit, the remote master application being further configured to transmit the commands to the remote slave application, the remote slave application being configured to send control signals to the sensor/actuator unit via the first and second transceiving circuitries to control the sensor/actuator unit according to the commands entered by the user of the master device.

10. A method for remotely communicating with a sensor/actuator unit of a wireless sensor/actuator system, the method comprising:
establishing a telecommunication connection between a master device and a cellular gateway device via a cellular network;
establishing a wireless connection between the cellular gateway device and a wireless sensor/actuator device using a first antenna and first transceiving circuitry of the wireless sensor/actuator device and a second antenna and second transceiving circuitry of the cellular gateway device, the first transceiving circuitry being connected to a sensor/actuator unit of the wireless sensor/actuator device; and
transmitting signals between the master device and the sensor/actuator unit of the wireless sensor/actuator device using the telecommunication connection between the master device and the cellular gateway device and the wireless connection between the cellular gateway device and the wireless sensor/actuator device so that the master device can communicate with the sensor/actuator unit.

11. The method of claim 10, further comprising measuring one or more physiological parameters of a person of interest or one or more physiological characteristics of the person of interest that provide information regarding one or more physiological parameters of the person of interest using the sensor/actuator unit and transmitting measurement signals to the master device via the cellular gateway device.

12. The method of claim 10, wherein measuring includes measuring one of temperature, heart rate and blood pressure of the person of interest.

13. The method of claim 10, further comprising detecting at least one of resistance, pressure and capacitance to detect urine and/or feces and transmitting detection signals to the master device via the cellular gateway device.

14. The method of claim 10, further comprising sensing lighting conditions around a lighting device and controlling the lighting device in response to commands entered at the master device.

15. The method of claim 14, wherein the controlling the lighting device includes controlling current applied to the lighting device.

16. The method of claim 10, wherein the establishing the telecommunication connection between the master device and the cellular gateway device includes establishing the telecommunication connection between a cellular phone and the cellular gateway device via the cellular network.

17. The method of claim 10, wherein the transmitting the signals between the master device and the sensor/actuator unit includes:
collecting data samples generated by the sensor/actuator unit at the cellular gateway device;
transmitting the data samples from the cellular gateway device to the master device; and
processing the data samples at the master device to present the data samples or any parameter computed from the data samples to a user of the master device.

18. The method of claim 10, wherein the transmitting the signals between the master device and the sensor/actuator unit includes:
providing a user interface at the master device for a user of the master device to enter commands to control the sensor/actuator unit;
transmitting the commands from the master device to the cellular gateway device; and
sending control signals from the cellular gateway device to the sensor/actuator unit to control the sensor/actuator unit according to the commands entered by the user of the master device.

19. A cellular gateway device of a wireless sensor/actuator system, the cellular gateway device comprising:
an antenna;
transceiving circuitry connected to the antenna, the transceiving circuitry being configured to establish a wireless connection with another transceiving circuitry of a wireless sensor/actuator device that includes a sensor/actuator unit; and
a cellular transceiver configured to establish a telecommunication connection with a master device using a cellular network to allow the master device to communicate with the sensor/actuator unit through the telecommunication connected between the master device and the cellular gateway device and the wireless connection between the transceiving circuitry of the cellular gateway device and the another transceiving circuitry of the sensor/actuator device.

20. The cellular gateway device of claim 19, further comprising a remote slave application, the remote slave application being configured to collect data samples generated by the sensor/actuator unit and transmitted to the cellular gateway device via the transceiving circuitries, the remote slave application being further configured to pass the collected data samples to the master device.
